(19) United States
(12) Patent Application Publication
(10) Pub. No.: US 2010/0045876 A1
(43) Pub. Date: Feb. 25, 2010

(54) APPARATUS AND METHOD FOR SENSING AN ATSC SIGNAL IN LOW SIGNAL-TO -NOISE RATIO

(75) Inventors: Wen Gao, West Windsor, NJ (US); Hou-Shin Chen, Piscataway, NJ (US)

Correspondence Address: Robert D. Shedd, Patent Operations;THOMSON Licensing LLC, P.O. Box 5312, Princeton, NJ, 08543-5312, US

(73) Assignee: THOMSON LICENSING CORPORATION, Princeton, NJ (US)

(21) Appl. No.: 12/448,487

(22) PCT Filed: Jun. 20, 2007
(86) PCT No.: PCT/US2007/014576

§ 371 Date: Jun. 22, 2009

Related U.S. Application Data
(60) Provisional application No. 60/880,081, filed on Jan. 12, 2007.

(51) Int. Cl. H04N 5/50

(52) U.S. Cl. 348/731; 348/E05.097

(57) ABSTRACT

A Wireless Regional Area Network (WRAN) receiver comprises a transceiver for communicating with a wireless network over one of a number of channels, and a signal detector for use in forming a supported channel list comprising those ones of the number of channels upon which an Advanced Television Systems Committee (ATSC) signal was not detected. The WRAN receiver performs a method comprising the steps of: dividing a total observation time looking for an ATSC data segment sync signal into multiple slices; computing at least one statistic for each slice; computing at least one overall statistic from the statistics computed for each slice; determining if the at least one overall statistic is greater than a threshold; and if the overall statistic is greater than the threshold, determining that an ATSC signal is present, otherwise, determining that an ATSC signal is not present.

### BACKGROUND OF THE INVENTION

The present invention generally relates to communications systems and, more particularly, to wireless systems, e.g., terrestrial broadcast, cellular, Wireless-Fidelity (Wi-Fi), satellite, etc.

A Wireless Regional Area Network (WRAN) system is being studied in the IEEE 802.22 standard group. The WRAN system is intended to make use of unused television (TV) broadcast channels in the TV spectrum, on a non-interfering basis, to address, as a primary objective, rural and remote areas and low population density underserved markets with performance levels similar to those of broadband access technologies serving urban and suburban areas. In addition, the WRAN system may also be able to scale to serve denser population areas where spectrum is available. Since one goal of the WRAN system is not to interfere with TV broadcasts, a critical procedure is to robustly and accurately sense the licensed TV signals that exist in the area served by the WRAN (the WRAN area).

In the United States, the TV spectrum currently comprises ATSC (Advanced Television Systems Committee) broadcast signals that co-exist with NTSC (National Television Systems Committee) broadcast signals. The ATSC broadcast signals are also referred to as digital TV (DTV) signals. Currently, NTSC transmission will cease in 2009 and, at that time, the TV spectrum will comprise only ATSC broadcast signals.

Since, as noted above, one goal of the WRAN system is to not interfere with those TV signals that exist in a particular WRAN area, it is important in a WRAN system to be able to detect ATSC broadcasts. One known method to detect an ATSC signal is to look for a small pilot signal that is a part of the ATSC signal. Such a detector is simple and includes a phase lock-loop with a very narrow bandwidth filter for extracting the ATSC pilot signal. In a WRAN system, this method provides an easy way to check if a broadcast channel is currently in use by simply checking if the ATSC detector provides an extracted ATSC pilot signal. Unfortunately, this method may not be accurate, especially in a very low signal-to-noise ratio (SNR) environment. In fact, false detection of an ATSC signal may occur if there is an interfering signal present in the band that has a spectral component in the pilot carrier position.

### SUMMARY OF THE INVENTION

In order to improve the accuracy of detecting ATSC broadcast signals in very low signal-to-noise ratio (SNR) environments, segment sync symbols and field sync symbols embedded within an ATSC DTV signal are utilized to improve the detection probability, while reducing the false alarm probability. In particular, and in accordance with the principles of the invention, an apparatus comprises a transceiver for communicating with a wireless network over one of a number of channels, and a signal detector for sampling a signal on one of the channels over a number of time intervals to form an overall statistical measure and for determining if an incumbent signal is present as a function of the overall statistical measure.

In an illustrative embodiment of the invention, the transceiver is a Wireless Regional Area Network (WRAN) transceiver, the incumbent signal is an ATSC broadcast signal and the signal detector samples the channel over the number of time intervals to form an overall statistical measure as to the presence of an ATSC data segment sync signal.

In another illustrative embodiment of the invention, a receiver is a Wireless Regional Area Network (WRAN) receiver and the incumbent signal is an ATSC broadcast signal. The WRAN receiver performs a method comprising the steps of: dividing a total observation time looking for an ATSC data segment sync signal into multiple slices; computing at least one statistic for each slice; computing at least one overall statistic from the statistics computed for each slice; determining if the at least one overall statistic is greater than a threshold; and if the overall statistic is greater than the threshold, determining that an ATSC signal is present, otherwise, determining that an ATSC signal is not present.

In view of the above, and as will be apparent from reading the detailed description, other embodiments and features are also possible and fall within the principles of the invention.

### BRIEF DESCRIPTION OF THE DRAWINGS

FIG. 1 shows Table One, which lists television (TV) channels;

FIGS. 2 and 3 show a format for an ATSC DTV signal;

FIG. 4 shows an illustrative WRAN system in accordance with the principles of the invention;

FIG. 5 shows an illustrative flow chart in accordance with the principles of the invention for use in the WRAN system of FIG. 4;

FIG. 6 shows another illustrative flow chart in accordance with the principles of the invention;

FIG. 7 shows an illustrative receiver for use in the WRAN system of FIG. 4 in accordance with the principles of the invention; and

FIG. 8 shows an illustrative signal detector in accordance with the principles of the invention.

### DETAILED DESCRIPTION

Other than the inventive concept, the elements shown in the figures are well known and will not be described in detail. Also, familiarity with television broadcasting, receivers and video encoding is assumed and is not described in detail herein. For example, other than the inventive concept, familiarity with current and proposed recommendations for TV standards such as NTSC (National Television Systems Committee), PAL (Phase Alternating Lines), SECAM (SEquential Couleur Avec Memoire), ATSC (Advanced Television Systems Committee), and networking, such as IEEE 802.16, 802.11 h, etc., is assumed. Further information on ATSC broadcast signals can be found in the following ATSC standards: Digital Television Standard (A/53), Revision C, including Amendment No. 1 and Corrigendum No. 1, Doc. A/53C; and Recommended Practice: Guide to the Use of the ATSC Digital Television Standard (A/54). Likewise, other than the inventive concept, transmission concepts such as eight-level vestigial sideband (8-VSB), Quadrature Amplitude Modulation (QAM), orthogonal frequency division multiplexing (OFDM) or coded OFDM (COFDM)), and receiver components such as a radio-frequency (RF) front-end, or receiver section, such as a low noise block, tuners, and demodulators, correlators, leak integrators and squarers is assumed. Similarly, other than the inventive concept, formatting and encoding methods (such as Moving Picture Expert Group (MPEG)-2 Systems Standard (ISO/IEC 13818-1)) for generating transport bit streams are well-known and not described herein. It should also be noted that the inventive concept may be implemented using conventional programming techniques, which, as such, will not be described herein. Finally, like-numbers on the figures represent similar elements.

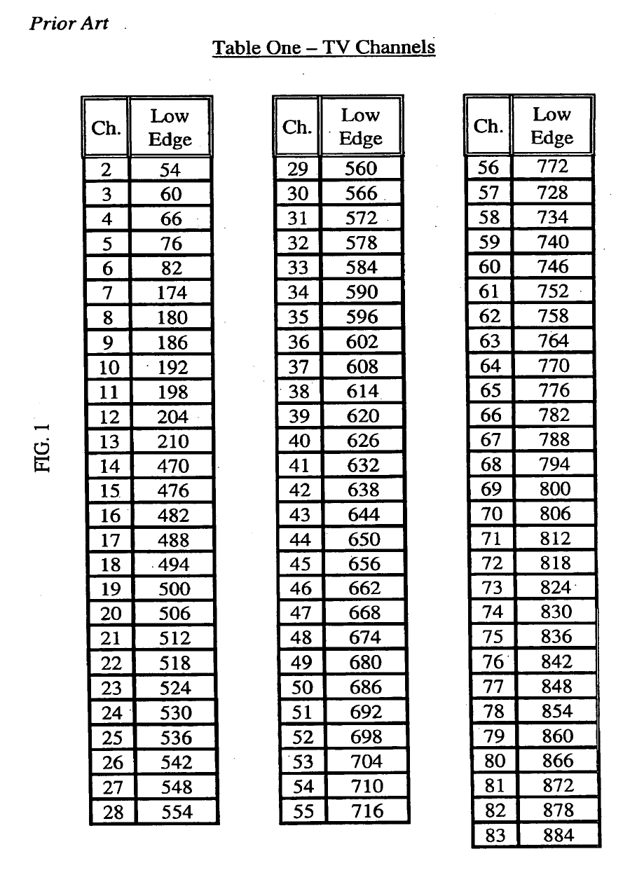

A TV spectrum for the United States is shown in Table One of FIG. 1, which provides a list of TV channels in the very high frequency (VHF) and ultra high frequency (UHF) bands. For each TV channel, the corresponding low edge of the assigned frequency band is shown. For example, TV channel 2 starts at 54 MHz (millions of hertz), TV channel 37 starts at 608 MHz and

TV channel 68 starts at 794 MHz, etc. As known in the art, each TV channel, or band, occupies 6 MHz of bandwidth. As such, TV channel 2 covers the frequency spectrum (or range) 54 MHz to 60 MHz, TV channel 37 covers the band from 608 MHz to 614 MHz and TV channel 68 covers the band from 794 MHz to 800 MHz, etc. In the context of this description, a TV broadcast signal is a “wideband” signal. As noted earlier, a WRAN system makes use of unused television (TV) broadcast channels in the TV spectrum. In this regard, the WRAN system performs “channel sensing” to determine which of these TV channels are actually active (or “incumbent”) in the WRAN area in order to determine that portion of the TV spectrum that is actually available for use by the WRAN system.

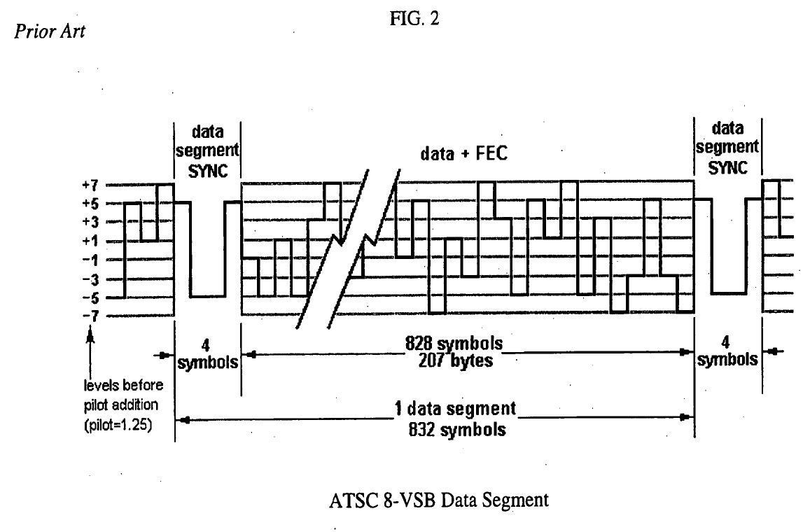

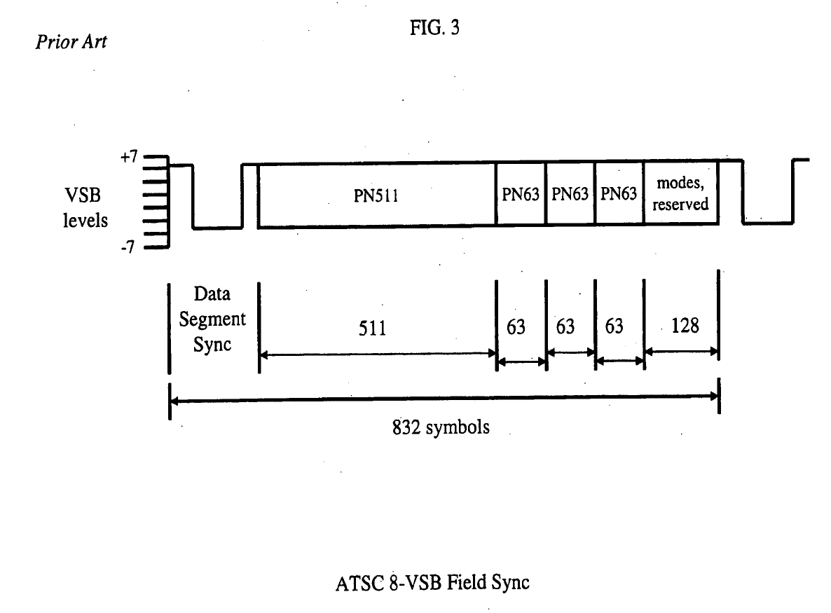

In this example, it is assumed that each TV channel is associated with a corresponding ATSC broadcast signal. The ATSC broadcast signal is also referred to herein as a digital TV (DTV) signal. The format of an ATSC signal is shown in FIGS. 2 and 3. DTV data is modulated using 8-VSB (vestigial sideband) and transmitted in data segments. An ATSC data segment is shown in FIG. 2. The ATSC data segment consists of 832 symbols: four symbols for data segment sync, and 828 data symbols. As can be observed from FIG. 2, the data segment sync is inserted at the beginning of each data segment and is a two-level (binary) four-symbol sequence representing the binary 1001 pattern. Multiple data segments (313 segments) comprise an ATSC data field, which comprises a total of 260,416 symbols (832×313). The first data segment in a data field is called the field sync segment. The structure of the field sync segment is shown in FIG. 3, where each symbol represents one bit of data (two-level). In the field sync segment, a pseudo-random sequence of 511 bits (PN511) immediately follows the data segment sync. After the PN511 sequence, there are three identical pseudo-random sequences of 63 bits (PN63) concatenated together, with the second PN63 sequence being inverted every other data field.

The data segment sync and field sync are representative of signature signals for an ATSC broadcast signal. For example, detection of the data segment sync pattern in a received signal can be used to identify the received signal as an ATSC broadcast signal. As such, in order to improve the accuracy of detecting ATSC broadcast signals in very low signal-to-noise ratio (SNR) environments, data segment sync symbols and field sync symbols embedded within an ATSC DTV signal are utilized to improve the detection probability, while reducing the false alarm probability. In particular, and in accordance with the principles of the invention, an apparatus comprises a transceiver for communicating with a wireless network over one of a number of channels, and a signal detector for sampling a channel over a number of time intervals to form an overall statistical measure and for determining if an incumbent signal is present as a function of the overall statistical measure. In an illustrative embodiment of the invention, the receiver is a Wireless Regional Area Network (WRAN) receiver, the incumbent signal is an ATSC broadcast signal and the signal detector samples the channel over the number of time intervals to form an overall statistical measure as to the presence of an ATSC segment sync signal.

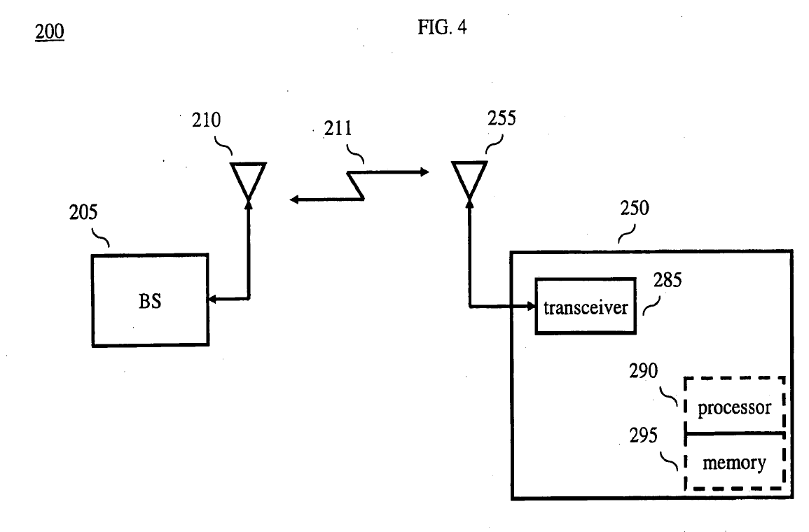

An illustrative Wireless Regional Area Network (WRAN) system 200 incorporating the principles of the invention is shown in FIG. 4. WRAN system 200 serves a geographical area (the WRAN area) (not shown in FIG. 4). In general terms, a WRAN system comprises at least one base station (BS) 205 that communicates with one, or more, customer premise equipment (CPE) 250. The latter may be stationary. CPE 250 is a processor-based system and includes one, or more, processors and associated memory as represented by processor 290 and memory 295 shown in the form of dashed boxes in FIG. 4. In this context, computer programs, or software, are stored in memory 295 for execution by processor 290. The latter is representative of one, or more, stored-program control processors and these do not have to be dedicated to the transceiver function, e.g., processor 290 may also control other functions of CPE 250. Memory 295 is representative of any storage device, e.g., random-access memory (RAM), read-only memory (ROM), etc.; may be internal and/or external to CPE 250; and is volatile and/or non-volatile as necessary. The physical layer of communication between BS 205 and CPE 250, via antennas 210 and 255, is illustratively OFDM-based via transceiver 285 and is represented by arrows 211. To enter a WRAN network, CPE 250 first attempts to “associate” with BS 205. During this attempt, CPE 250 transmits information, via transceiver 285, on the capability of CPE 250 to BS 205 via a control channel (not shown). The reported capability includes, e.g., minimum and maximum transmission power, and a supported, or available, channel list for transmission and receiving. In this regard, CPE 250 performs “channel sensing” in accordance with the principles of the invention to determine which TV channels are not active in the WRAN area. The resulting available channel list for use in WRAN communications is then provided to BS 205. The latter uses the above-described reported information to decide whether to allow CPE 250 to associate with BS 205.

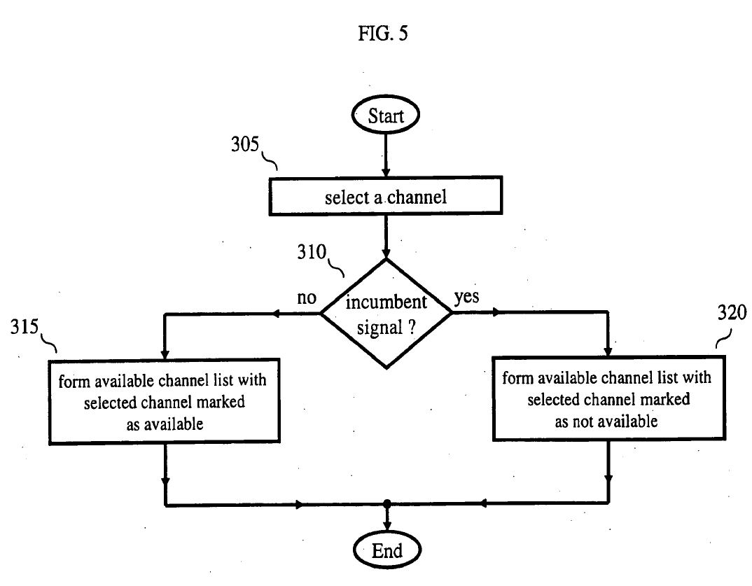

Turning now to FIG. 5, an illustrative flow chart for use in performing channel sensing in accordance with the principles of the invention is shown. The flow chart of FIG. 5 can be performed by CPE 250 over all of the channels, or only over those channels that CPE 250 has selected for possible use. Preferably, in order to detect incumbent signals in a channel, CPE 250 should cease transmission in that channel during the detection period. In this regard, BS 205 may schedule a quiet interval by sending a control message (not shown) to CPE 250. In step 305, CPE 250 selects a channel. In this example, the channel is assumed to be one of the TV channels shown in Table One of FIG. 1 but the inventive concept is not so limited and applies to other channels having other bandwidths. In step 310, CPE 250 scans the selected channel to check for the existence of an incumbent signal. In particular, CPE 250 samples the selected channel over a number of time intervals to form an overall statistical measure for use in determining if an incumbent signal is present (described further below). If no incumbent signal has been detected, then, in step 315, CPE 250 indicates the selected channel as available for use by the WRAN system on an available channel list (also referred to as a frequency usage map). However, if an incumbent signal is detected, then, in step 320, CPE 250 marks the selected channel as not available for use by the WEAN system. As used herein, a frequency usage map is simply a data structure stored in, e.g., memory 295 of FIG. 4, that identifies one, or more, channels, and parts thereof, as available or not for use in the WRAN system of FIG. 4. It should be noted that marking a channel as available or not can be done in any number of ways. For example, the available channel list may only list those channel that are available, thus effectively indicating other channels as not available. Similarly, the available channel list may only indicate those channels that are not available, thus effectively indicating other channels as available.

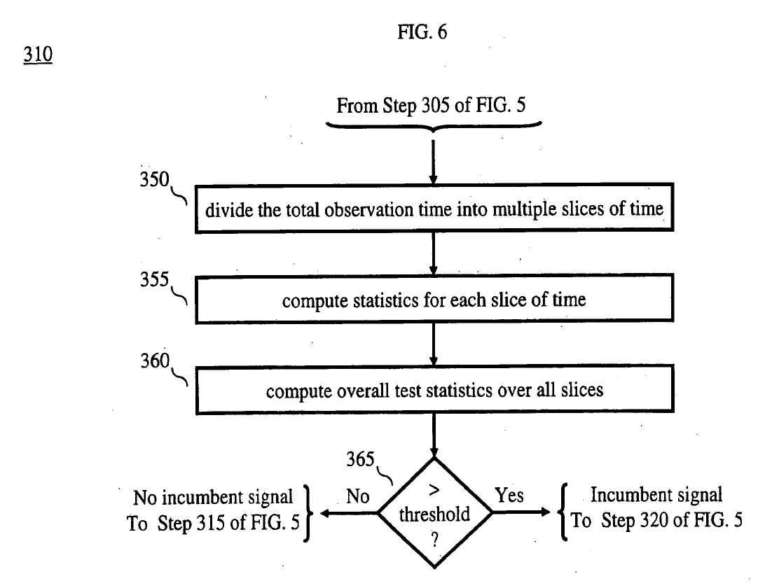

An illustrative flow chart for performing step 310 of FIG. 5 is shown in FIG. 6. In the flow chart of FIG. 6, CPE 250 looks for an ATSC data segment sync signal on the selected channel. In step 350, CPE 250 divides a total observation time into multiple slices of time (time slices). In step 355, CPE 250 computes at least one test statistic (T) in each time slice for a received baseband signal y[n] on the selected channel. An illustrative equation that can be used for determining T for each time slice is:

$$T = {max}_{0 \leq i \leq L - 1} \vert \frac{1}{{N}_{D}} {\sum }_{n = 0}^{{N}_{D} - 1} \frac{1}{K} {\sum }_{k = 0}^{K - 1} \begin{matrix}y [ i + k \cdot M + n \cdot L ] \\ {y}^{*} [ i + k \cdot M + ( n + 1 ) L ]\end{matrix} \vert \qquad ( 1 )$$

where i, n and k are indexes. The variable N_{D} is the number of collected segments illustratively including data segment and field sync segments, which are used for the computation of the test statistic over a time slice. As used herein, the term “collected segment” is just a segment that is used to compute the test statistics within a particular time slice. The variable L is the number of samples per segment, e.g., if the sample rate is twice the symbol rate, L=2*832=1664 and if the sample rate equals the symbol rate, L=832. The variable K is the number of data used in a sliding window addition, e.g., if the sample rate is twice the symbol rate, K=8 or K=4; and if the sample rate equals the symbol rate, K=4. The variable M indicates that in the sliding window addition, every M data are added together in the sliding window addition; if the sample rate is twice the symbol rate, M=2 means every other data are added together in the sliding window addition; while if the sample rate equals the symbol rate, M is always 1 indicating consecutive data are added together in the sliding window. The variable y[n] is the sequence of the base-band samples for the received signal on the selected channel. Illustratively, if the sample rate is twice the symbol rate, the following values can be used:
K=8, M=1;
K=4, M=2; and
K=4, M=1.
   If the sample rate equals the symbol rate, the only combination that can be used is: K=4, M=1. In step 360, CPE 250 computes at least one overall statistic over all of the T values for each time slice. For example, CPE 250 computes an average value over all T values. In step 365, CPE 250 compares the average value for T to a threshold value (which can be determined experimentally as a function of the false alarm rate required by the system). If the average value for T is greater than the threshold value, then an ATSC signal is present. However, if the average value for T is less than, or equal to, the threshold value, then an ATSC signal is not present.

An illustrative value for a total observation time is 100 millisec., with 10 time slices. The value of 100 millisec. for the total observation time corresponds to slightly more than 4 ATSC fields. However, total observation times with longer, or shorter, values may be used. A value for the total observation time can be determined on a case by case basis as a function of how fast an incumbent signal must be detected. For example, in an 802.22 WRAN system, a wireless endpoint (e.g., CPE 250 or BS 205) should detect the presence of an incumbent signal and move out of the occupied channel in 2 seconds. It should be noted that the time slices do not have to be contiguous within the total observation time. For example, within a total observation time of 100 millisec, each time slice may have a value of 4.06 millisec. or 9.25 millisec.

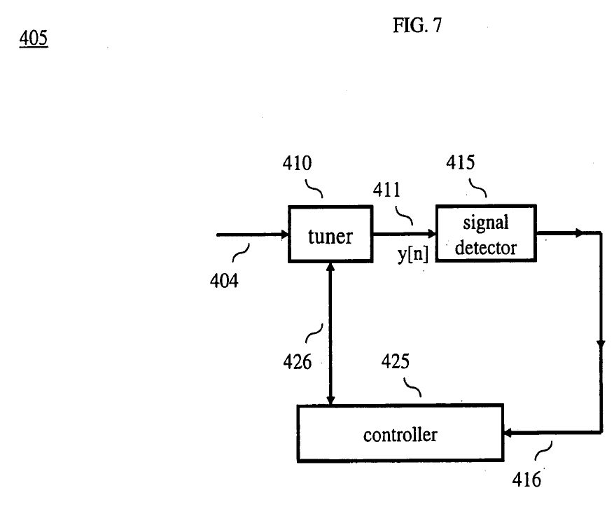

Turning briefly to FIG. 7, an illustrative portion of a receiver 405 for use in CPE 250 is shown (e.g., as a part of transceiver 285). Only that portion of receiver 405 relevant to the inventive concept is shown. Receiver 405 comprises tuner 410, signal detector 415 and controller 425. The latter is representative of one, or more, stored-program control processors, e.g., a microprocessor (such as processor 290), and these do not have to be dedicated to the inventive concept, e.g., controller 425 may also control other functions of receiver 405. In addition, receiver 405 includes memory (such as memory 295), e.g., random-access memory (RAM), read-only memory (ROM), etc.; and may be a part of, or separate from, controller 425. For simplicity, some elements are not shown in FIG. 7, such as an automatic gain control (AGC) element, an analog-to-digital converter (ADC) if the processing is in the digital domain, and additional filtering. Other than the inventive concept, these elements would be readily apparent to one skilled in the art. In this regard, the embodiments described herein may be implemented in the analog or digital domains. Further, those skilled in the art would recognize that some of the processing may involve complex signal paths as necessary.

In the context of the above-described flow charts, tuner 410 is tuned to different ones of the channels by controller 425 via bidirectional signal path 426 to select particular TV channels. For each selected channel, an input signal 404 may be present. Input signal 404 may represent an incumbent signal such as a digital VSB modulated signal in accordance with the above-mentioned “ATSC Digital Television Standard”. Tuner 410 provides a downconverted signal 411 (the above-referenced y[n]) to signal detector 415, which processes signal 411 to determine if signal 404 is an incumbent signal in accordance with the principles of the invention. Signal detector 415 provides the resulting information to controller 425 via path 416.

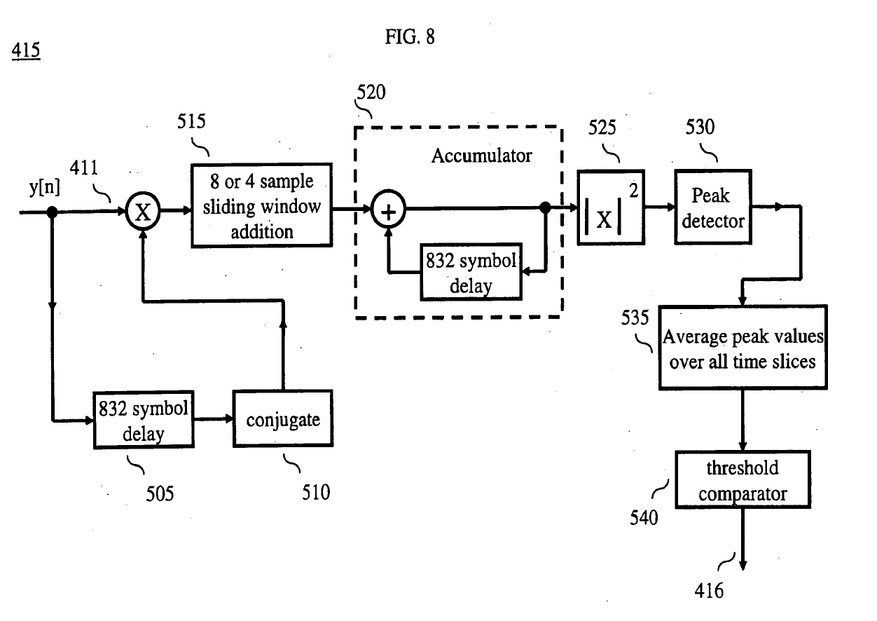

Referring now to FIG. 8, an illustrative embodiment of signal detector 415 is shown. The input signal, 411, is multiplied by a delayed, conjugated version of itself (505, 510). The result is applied to an 8 or 4 sample sliding window addition element 515 (as illustrated in equation (1) above). The output signal from element 515 is applied to accumulator 520. Following accumulator 520, the magnitude (525) of the signal is taken (or more easily, the magnitude squared is taken as I²+Q², where I and Q are in-phase and quadrature components, respectively, of the signal out of the accumulator). The maximum value among the various magnitude values in each time slice is determined in peak detector 530. The peak values of all time slices are averaged together by element 535 and the result is provided to threshold comparator 540 for comparison with the threshold value.

As can be observed from the above, the inventive concept has been described in the context of looking for one of the signature signals (e.g., the ATSC data segment sync signal) present in an ATSC broadcast signal. However, the inventive concept is not so limited. For example, the inventive concept can be used in combination with detection of the ATSC field sync signal. Indeed, the inventive concept is applicable to detecting any signal that includes one, or more, signature signals. Further, the inventive concept can be combined with other techniques for detecting the presence of a signal, e.g., energy detection,. etc. It should also be noted that although the inventive concept was described in the context of CPE 250 of FIG. 4, the invention is not so limited and also applies to, e.g., a receiver of BS 205 that may perform channel sensing. Further, the inventive concept is not restricted to a WRAN system and may be applied to any receiver that performs channel sensing. Finally, although an average was used as an example of an overall statistical value, the inventive concept is not so limited and other measures may be used, e.g., a maximum value over all time slices, etc. Similarly, equation (1) is merely an example and other measures for statistics of a time slice may be used.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one, or more, integrated circuits (ICs). Similarly, although shown as separate elements, any or all of the elements (e.g., of FIG. 8) may be implemented in a stored-program-controlled processor, e.g., a digital signal processor, which executes associated software, e.g., corresponding to one, or more, of the steps shown in, e.g., FIGS. 5 and 6. Further, the principles of the invention are applicable to other types of communications systems, e.g., satellite, Wireless-Fidelity (Wi-Fi), cellular, etc. Indeed, the inventive concept is also applicable to stationary or mobile receivers. It is therefore to be understood that numerous modifications may be made to the illustrative embodiments and that other arrangements may be devised without departing from the spirit and scope of the present invention as defined by the appended claims.

1. A method for use in a wireless endpoint, the method comprising:
tuning to one of a number of channels;
sampling a signal on the tuned channel over a number of time intervals to form an overall statistical measure representative of a signature signal that is indicative of an incumbent signal; and
determining if the incumbent signal is present on the tuned channel as a function of the overall statistical measure.

2. The method of claim 1, wherein the signature signal is an Advanced Television Systems Committed (ATSC) data segment sync signal.

3. The method of claim 1, wherein the overall statistical measure is an average value.

4. The method of claim 1, wherein the overall statistical measure is a maximum value.

5. The method of claim 1, wherein the sampling step comprises:
dividing a total observation time into a number of time slices;
for each time slice, determining a statistical measure representative of the signature signal from the signal; and
determining the overall statistical measure from each of the statistical measures for each time slice.

6. The method of claim 5, wherein the number of time slices are not contiguous within the overall time interval.

7. The method of claim 1, wherein the determining step comprises:
comparing the overall statistical measure to a threshold value to determine if the incumbent signal is present.

8. The method of claim 1, further comprising the step of:
marking an available channel list to indicate that the tuned channel is available for use if no incumbent signal is present.

9. Apparatus comprising:
a tuner for tuning to one of a number of channels; and
a signal detector for sampling a signal on the tuned channel over a number of time intervals to form an overall statistical measure representative of a signature signal and for determining if an incumbent signal is present on the channel as a function of the overall statistical measure.

10. The apparatus of claim 9, wherein the signature signal is an Advanced Television Systems Committed (ATSC) data segment sync signal.

11. The apparatus of claim 9, wherein the overall statistical measure is an average value.

12. The apparatus of claim 9, wherein the overall statistical measure is a maximum value.

13. The apparatus of claim 9, wherein the number of time intervals are time slices and the signal detector comprises:
a multiplier for multiplying the signal with a delayed conjugate of the signal for providing an output signal;
an adder for performing sliding window addition on the output signal over a number of sample times;
an accumulator for accumulating an output of the adder over each time slice;
a peak detector for determining the maximum magnitude of the output from the accumulator over each time slice for use in forming an overall average for all the time slices; and
a threshold comparator for comparing the overall average to a threshold for determining if an incumbent ATSC signal is present on the channel.

14. The apparatus of claim 13, wherein the number of time slices are not contiguous.

15. The apparatus of claim 9, further comprising:
a memory for storing an available channel list to indicate that the tuned channel is available for use if no incumbent signal is present.
